(19) United States
(12) Patent Application Publication
(10) Pub. No.: US 2020/0353836 A1
(43) Pub. Date: Nov. 12, 2020

(54) METHOD FOR RESERVING AN ELECTRIC CHARGING STATION, AND CHARGING SYSTEM

(71) Applicant: AUDI AG, Ingolstadt (DE)

(72) Inventor: Jörg IMBERGER, Ingolstadt (DE)

(73) Assignee: AUDI AG, Ingolstadt (DE)

(21) Appl. No.: 16/765,367

(22) PCT Filed: Mar. 4, 2019
(86) PCT No.: PCT/EP2019/055307

§ 371 Date: May 19, 2020

(30) Foreign Application Priority Data
Mar. 15, 2018 (DE) 10 2018 203 942.9

(51) Int. Cl. B60L 53/66; G06Q 10/02

(52) U.S. Cl. CPC B60L 53/665; G06Q 10/02

(57) ABSTRACT

The approach relates to a method for using an electric charging station for charging an electric vehicle, in which an operator's electric charging station is made available to third parties, and a third party can charge an electric vehicle at the electric charging station if the electric charging station is authorized to him, characterized in that the electric charging station is reserved by a third party at a reservation time for a charging process in the future, the desired future charging process being at a time interval after the reservation time.

### TECHNICAL FIELD

The present disclosure relates to a method for using an electric charging station for charging an electric vehicle, in which an operator's charging station is made available to third parties, and a third party can charge an electric vehicle at the electric charging station if the electric charging station is authorized to him.

### BACKGROUND

An adapter and a method for connecting an electrical consumer to a charging network are known from the document DE 10 2008 048 657 A1. An adapter enables electrical consumers to participate in a charging network. The adapter allows, among other things, the acquisition of electrical energy via charging stations which are not specifically assigned to the buyer of the energy, that is to say do not have a meter approved for him. Electric and hybrid vehicles (plug-in vehicles) that can obtain electrical energy from a charging station via a power connection are particularly considered as consumers. The method is used for recording and billing transactions between a charging network operator and the user of a consumer.

An energy transmission connector, system and method are known from the document DE 10 2015 204 070 B3. In this case, an energy transmission connector and the corresponding system for transmitting energy are further improved, in particular with regard to the connection for an improper or fraudulent use. For this purpose, it is proposed that the energy transmission connector further comprises a position determination unit for determining a position of the energy transmission connector, wherein a) the energy transmission connector also comprises a receiver for receiving position information in response to the sent identification information, a storage unit in which position information is stored in a form assigned to identification information, and/or a position information reading unit for reading position information associated with the identification information from the energy filling station, and a comparison unit for comparing the determined position, the received, the stored and/or the read position information associated with the identification information, and/or b) the sending unit is also designed to send the determined position to the billing point.

An access control for electric charging stations is known from the document DE 10 2010 023 127 A1. This includes a method for access and session control of electrical generators and/or consumers at generally or jointly accessible energy transfer units, whereby an authentication and authorization of the generator or of the consumer takes place at the energy transfer unit and, after authentication and authorization of the generator or of the consumer, generator-specific or consumer-specific data are forwarded to an energy supplier (energy provider) by the energy transfer unit. Then a session token is generated for controlling the energy transfer by the energy supplier and the session token is forwarded to the energy transfer unit and to the producer or the consumer, the session token being valid for a limited time. During the energy transfer process, the session token is in each case sent at least once from the energy transfer unit to the generator or consumer and from the generator or consumer to the energy transfer unit in a defined time interval. In particular, the method enables simple and retrofittable access control to freely accessible sockets and public charging stations which can be used by electric vehicles in the future. In addition, the method enables retrofittable access control of decentralized (private and commercial) energy producers to smart grid networks. For example, electric vehicles can also feed in battery power when they are not in use (vehicle-to-grid (V2G) systems).

A disadvantage of these known systems is that the occupancy is limited and the charging station, in particular, can only be used flexibly to a limited extent by a user.

### SUMMARY

The object of the present disclosure is to make the use of an electric charging station more variable for third parties.

This object is achieved by a method and a charging system according to the independent claims. Expedient further developments result from the dependent claims.

One aspect of the present disclosure relates to a method for using an electric charging station for charging an electric vehicle, in which an operator's charging station is made available to third parties and a third party can charge an electric vehicle at the electric charging station if the electric charging station is authorized to him. The charging station is reserved by a third party at a reservation time for a charging process in the future, the desired future charging process being at a time interval after the reservation time.

More and more electric charging stations are needed for the increasing number of electric vehicles. In order to be able to meet this need, it should be possible for homeowners, companies, shops etc. to authorize their conventional sockets or existing electric charging stations for third parties. For this purpose, the sockets can be equipped with a device which permits remote activation of this socket. Thus, for example, a homeowner can modify an outlet near his parking space so that the outlet can be used by a third party. The third party can be enabled not to book the electric charging station on site, but to reserve the charging station. This means that a user can reserve the charging station for a future point in time, even if he is not on site at the charging station. He then knows for sure that the charging station is free at this time for his charging process. A charging station can thus be reserved in advance by a third party. This allows the charging station to be used more variably and also more flexibly. The occupancy rate of the charging station can be increased because it is not necessary to first check on site whether there is no vehicle currently connected for charging, in order then to be able to connect one's own vehicle for charging immediately, but rather it is possible to check reliably whether the charging station is free and available at a desired time in the future, and then a time interval in the future can be booked.

It would then also be possible if the person who ultimately takes up the reservation is not the person who made the reservation. For example, a work colleague can reserve a suitable charging station for a colleague who is traveling with an electric vehicle. This is particularly advantageous if the person who needs the charging station is unable to make a reservation. Of course, the person making the reservation can also be the one who will then carry out the charging process of an electric vehicle on site at the electric charging station in the booked future.

A reservation of the electric charging station preferably takes place at a reservation time. This reservation time is at a time interval before a future charging process. This means that the reservation time is, for example, a few minutes (e.g. 10, 20 or 30 minutes), a few hours (e.g. 2, 3, 5 or 10 hours) or a few days (e.g. 2, 7 or 10 days) before use of the charging station.

It is also possible to reserve the charging station directly on site but for a time interval in the future. For this purpose, the charging station can have a corresponding operating unit, which allows a person to reserve the charging station for any time in the future, if it is free then. For example, a person can reserve the charging station if the user knows that the battery of his electric vehicle will be empty, for example in a few hours, for example in 2 hours. He can reserve the charging station for a charging process that will only be needed in the future. For example, a reservation can be made in the morning for the evening of a day if a third party knows that he needs to charge the vehicle in the evening. These examples are by no means to be understood as definitive; they are only intended to clarify the different time intervals between a reservation time and the charging process which is then in the future. Thus the time interval is to be understood in such a way that the loading process does not take place immediately after the reservation.

The reservation can be carried out via an online portal. An online portal or an online platform is provided and used so that an electric charging station can be reserved. The online portal allows a third party to reserve a desired charging station. For example, the user can log into the online portal using a communication terminal, such as a smartphone, and then reserve a charging station located at the desired charging location. Every operator of an electric charging station can be present on the online portal so that the charging stations can be reserved by third parties.

The reservation can be carried out remotely from the charging station. Especially when a third party knows that he does not currently need a charging process for his electric vehicle and then knows where he will be, he can specifically search for electric charging stations that can be used by third parties and can then reserve the most suitable one. If a third party who is currently at a first location knows, for example, that he will be at a second location in the evening and then also needs to charge his electric vehicle due to the state of charge, he can already reserve a charging station at the second location. For example, during a business trip or when traveling on vacation or the like, a charging station at the destination can be reserved at a target time. The length of time that is then required, for example, at the second location for other matters, for example also for making appointments, can then also be used for charging the electric vehicle.

The person who wants to reserve the charging station may therefore not yet be at the electric charging station at the time of the reservation. In particular, the person cannot yet carry out the charging because, for example, he is still a long way from the electric charging station or cannot be there in a timely manner or currently does not want charging at all, but only at a later point in time. For example, a third party can reserve a charging station near his home after he has finished working. Or the state of charge of the battery of his electric vehicle is sufficient for one day, so he can reserve a desired charging station for tomorrow.

In particular, it can be provided that a search for an electric charging station that can be used by third parties is carried out automatically. This can be started by a third party, for example. The search can also be started automatically. For example, this can be dependent on a vehicle parameter of the electric vehicle, such as a current and/or expected future state of charge of the electric vehicle. In addition or instead of this, this can also depend on a target parameter. A target parameter can be, for example, the distance to the destination of the electric vehicle and/or the length of time to the destination and/or the expected change in the state of charge during the further journey of the electric vehicle. These target parameters, but also others, can be determined automatically, for example, on the basis of an input into a navigation system of the electric vehicle.

As a result, an electronic system of the electric vehicle can be used to reserve a charging station authorized for use by third parties, in particular completely independently.

The price per energy unit that is offered at the charging station can be changed depending on an influencing criterion. This means that an adaptation to changed conditions can take place dynamically.

For example, the influence cannot come from the operator itself, but from the online portal, which sets new usage prices or charges fees for logging in.

The price per energy unit can be changed individually by the operator.

For example, there are costs for repairs to the charging station or for the inspection and checking of the charging station by experts. Likewise, new functions can be installed on the charging station, which make it easier to use the charging station.

Criteria influencing the uses prices or charge fees can include a time of day, an occupancy rate of the charging station with reservations in the past and/or in the future, the type of electric vehicles that have used the charging station in a time interval in the past and/or will use it in the future, and/or the duration of individual charging processes for which the charging station was used in the past by third parties and/or will be used in the future.

An influencing criterion can also include the occupancy rate of the electric charging station. The higher the occupancy rate of the charging station, the more operating costs are incurred. The occupancy rate also depends on the time of day. Here there are certain peak times when the occupancy rate can be increased. For example, the electric vehicles can be charged after the end of work or at night. It is also important here how many people have reserved the same charging station, for example. A further influencing criterion is determined by the type of electric vehicle. The charging time differs according to the type of electric vehicle. The capacity or the state of the battery is decisive for how long the charging process lasts. The longer the charging process per vehicle lasts, the fewer vehicles can use the charging station. If there is a high number of reservations for future use of the charging station in the future, this is a further influencing criterion.

The amount of the energy unit withdrawn by a third party's electric vehicle during a charging process at the charging station and/or the duration of a charging process by a third party's electric vehicle is measured. In order that the price for a charging process can be determined, the amount of the energy unit withdrawn during the charging process should be measured. The costs for the charging process are then determined on the basis of the energy unit withdrawn.

A further aspect comprises the measurement of the duration of a charging process.

This provides a better overview of the occupancy rate and availability of the charging station. The recorded time can be used to determine when the charging station is available again. Statistics and forecasts can also be sought over the period of time so that the charging station can be used optimally.

The information about the amount and/or duration is transmitted to an online portal. The information can then be viewed by a third party. This enables him to check his charging behavior for the past.

Thus, the operator and the user, who is the third party, of an electric charging station can also see the amount and duration of a charging process individually at any time. The information can be sent to the online portal by means of a communication unit at the charging station. The information is displayed on the online portal and saved if desired. Thus the operator can determine the occupancy rate of his charging station based on the amount and the duration. The user can, for example, have a receipt of his last charging process printed out.

When the electric vehicle arrives at the charging station after the reservation, the third party identifies himself as authorized to use the charging station to carry out the previously reserved charging process. This identification can be carried out directly on site when the third party is in front of the charging station with his electric vehicle and can then start the charging process immediately after identification.

It should be ensured that there is no unauthorized misuse of a charging station. Likewise, the charging station that a user has reserved should not be occupied by another user. The person making a reservation should receive a reservation key. This reservation key can be, for example, a combination of numbers or a code. The reservation key is assigned exactly to the corresponding reservation, i.e. the exact time of use of the charging process and the location of the charging station. Thus the user can authorize the charging station with the reservation key. It would also be conceivable for the charging station to be activated using a smartphone app.

In some embodiments, the reservation must be confirmed in a time window before the start time of the charging process, which is in the future. For example, it can be provided that the operator of the charging station or the charging station itself, in particular automatically, asks the person making the reservation whether he still wants his charging process and/or wants to or is able to keep the reserved start time of the charging process and/or the reserved total duration for the charging process unchanged. If this is not confirmed, the reserved charging process can be deleted. Another third party can then make a reservation at short notice. This can avoid idle times of the charging station. Reservations that are not recognized and that were not actively canceled by the third party, especially early, can also be avoided.

A waiting list for a reservation of the electric charging station can also be created. If, for example, a reservation has already been made by a first third party and subsequently a reservation is requested by at least one further third party at this time interval in the future of the already existing reservation, this already existing reservation can be communicated to the further third party. In particular, the electronic system of the charging station can then offer to place the further third party on a waiting list. If this is desired, the other third party can be informed if the first third party has canceled their reservation or it has been canceled by the operator. This also enables efficient use of the electric charging station for third parties.

A further aspect of the present disclosure relates to a charging system for electrically charging an electric vehicle, which has at least one electric charging station of an operator, the charging station being designed for use by third parties, and with a reservation function by which a third party can reserve the charging station for a time interval before a charging process occurring in the future.

In order to be able to charge the vehicle battery of an electric vehicle, a charging system which is capable of charging the battery is required. The charging system can have at least one charging station (e.g. conventional 230 V socket or a wall box). The charging station can be provided by any operator (company or simply a homeowner). The charging station can be designed so that it can be used by third parties. The charging station can also be equipped, for example, with a device which can lock the charging station and can only be used by an authorized user. For this purpose, it has an optional identification system where the user can authorize the charging station for a charging process.

The charging station can be designed with a reservation function. With the reservation function, in particular, the embodiments of the method can be implemented.

The reservation function enables the charging station to be reserved, the time of the charging process being at a time interval after a reservation time. A user can reserve the charging station at a desired time by means of an online portal.

The charging station can have a user interface with an identification system. Here the user of the reserved charging station can identify himself and thereby authorize the charging station and thus start the charging process. The charging station should also be designed with a measuring unit for recording the amount of the energy unit taken up and the duration of the charging process. With these measurement data, the costs for the charging process can be determined following the charging process. The measurement data are optionally transmitted to the online portal so that the operator and the user of the charging station can see the amount and duration of the charging process.

The present disclosure also includes the combinations of the described embodiments.

### BRIEF DESCRIPTION OF THE DRAWING

Further advantages, features and details of the present disclosure will become apparent from the claims, the following description of example embodiments and from the drawings.

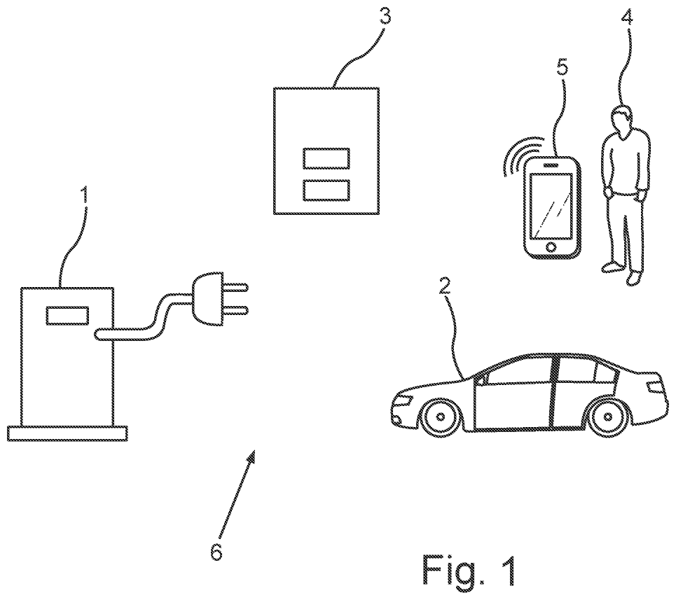

In the following an exemplary embodiment of the invention is described. The sole figure (FIG. 1) shows a schematic sequence of an embodiment of the method according to the invention.

### DETAILED DESCRIPTION

In the example embodiments described below, the described components constitute individual features of the present disclosure that are to be considered independently of one another, which features contribute independently to the development of the present disclosure, and should thus be considered individually or in a combination other than that shown to be a constituent of the present disclosure. In addition, features additional to those already described can also be added to the described embodiments.

FIG. 1 shows an exemplary method for using an electric charging station 1 of a charging system 6 for charging an electric vehicle 2, in which an operator's charging station 1 is made available to third parties, and a third party can charge an electric vehicle 2 at the electric charging station 1 if the electric charging station 1 is authorized to him. The electric charging station 1 can be reserved by a third party at a reservation time for a charging process in the future, the desired future charging process being a greater time interval after the reservation time. The reservation time is, for example, a few hours or even days before the time of use of the electric charging station 1. The electric charging station 1 can be designed with an identification system for third parties, so that access to the electric charging station 1 is controlled in a defined manner. At the time of reservation, the third party with his electric vehicle 2 is not at the electric charging station 1 but locally, possibly more remote therefrom. In particular, the third party can also be in a different location from the location of the electric charging station 1, so that at the time of reservation it would not be possible for him to be at the electric charging station 1 immediately.

The electric charging station 1 can be reserved via an online portal 3. The operator of an electric charging station 1 has the option of making his electric charging station 1 accessible to third parties via an online portal. For example, a user 4, who represents a third party, can register in the online portal 3 by means of a smartphone 5 and can reserve the electric charging station 1. The user 4 receives a reservation key with which he can identify himself at the electric charging station 1 in order thus to authorize the electric charging station 1 for him. For example, the reservation key can be a code that can be entered on the identification system in order to authorize the electric charging station 1. Another conceivable variant would be the identification using a smartphone app on the smartphone 5. Authorization could be granted here, for example, by means of short-range radio communication between the electric charging station 1 and the smartphone 5.

The electrical charging system 6 can be designed with two measuring units, by which the amount of the energy unit and the duration of the charging process are measured. However, only one measuring unit can also be present. With these measurement data, the costs for a charging process can be determined and the occupancy rate and availability of the electric charging station 1 can be documented. The measurement data can be transmitted to the online portal 3 so that the operator and the user 4 of the electric charging station 1 can see the data. Thus the user 4 has an overview of his charging processes and the operator can monitor the occupancy rate of his electric charging station 1.

The electric charging station 1 can typically be a wall box or a conventional 230 V socket. This means that an operator can make his socket available to third parties near his parking space, for example. This makes the homeowner the operator of an electric charging station 1. He can then make this available to third parties via an online portal 3. The socket is then, for example, provided with a device so that it can be locked and cannot be used arbitrarily. This can takes place, for example, with an identification system. The measuring unit for recording the amount of energy taken up and the duration of the charging process is integrated in the device. Furthermore, it should be checked what energy output the socket allows. The performance also has an influence on the duration of the charging process of an electric vehicle 2. The more powerful the socket, that is the charging system 6, the faster the battery of the electric vehicle 2 can be charged.

1.-10. (canceled)

11. A computer-implemented method for using an electric charging station of an operator for charging an electric vehicle by third parties, the method comprising:
generating, by one or more computing devices associated with the electric charging station, a reservation for a third party to perform a charging process using the electric charging station at a future reservation time, wherein a start time of the charging process is to occur at a time interval after the future reservation time;
during a time window before the start time of the charging process, providing, by the one or more computing devices, a prompt to the third party asking whether the third party would like to keep the reservation;
receiving, by the one or more computing devices, a response to the prompt from the third party indicating that the third party would not like to keep the reservation;
in response to receiving the response to the prompt, deleting, by the one or more computing devices, the reservation.

12. The method according to claim 11, further comprising, subsequent to deleting the reservation, generating, by the one or more computing devices, a second reservation for a second third party at the future reservation time.

13. The method according to claim 11, further comprising creating, by the one or more computing devices, a waiting list for reserving the charging station.

14. The method according to claim 13, further comprising:
receiving, by the one or more computing devices, a request from a second third party to reserve the charging station at the future reservation time; and
denying, by the one or more computing devices, the reservation for the second third party.

15. The method according to claim 14, further comprising placing, by the one or more computing devices, the second third party on the waiting list.

16. The method according to claim 15, further comprising, in response to receiving the response to the prompt, informing the second third party that the third party's reservation has been deleted.

17. The method according to claim 11, wherein generating the reservation comprises generating the reservation via an online portal, and wherein the method further comprises receiving, by the one or more computing devices, a request for the reservation from the third party via the online portal.

18. The method according to claim 11, further comprising, determining, by the one or more computing devices, a price per energy unit offered at the electric charging station based at least in part influencing criteria, the influencing criteria comprising at least one of a time of day, an occupancy rate of the electric charging station, a type of one or more electric vehicles that have used the electric charging station during a time interval proximate the future reservation time, or a duration of one or more charging processes performed by the electrical charging station during a time interval proximate the future reservation time.

19. The method according to claim 11, further comprising:
measuring, by the one or more computing devices, at least one of an amount of energy units withdrawn by a second third party's electric vehicle during a second charging process at the electric charging station, or a duration of the second charging process; and
providing, by the one or more computing devices, information indicative of the at least one of the amount of energy units or the duration to an online portal such that the second third party can view the information indicative of the at least one of the amount of energy units or the duration via the online portal.

20. A charging system for electrically charging an electric vehicle, the charging system having at least one electrical charging station of an operator, the charging system comprising one or more control devices configured to:
generate a reservation for a third party to perform a charging process using an electrical charging station of the at least one electrical charging station at a future reservation time, wherein a start time of the charging process is to occur at a time interval after the future reservation time;
during a time window before the start time of the charging process, provide a prompt to the third party asking whether the third party would like to keep the reservation;
receive a response to the prompt from the third party indicating that the third party would not like to keep the reservation;
in response to receiving the response to the prompt, delete the reservation.
